(19) United States
(12) Patent Application Publication
(10) Pub. No.: US 2015/0216372 A1
(43) Pub. Date: Aug. 6, 2015

(54) HAND DRIER

(71) Applicant: Syed Ahmed, London (GB)

(72) Inventor: Syed Ahmed, London (GB)

(21) Appl. No.: 14/424,611

(22) PCT Filed: Jul. 9, 2013
(86) PCT No.: PCT/GB2013/051813

§ 371 Date: Feb. 27, 2015

(30) Foreign Application Priority Data
Aug. 30, 2012 (GB) 1215410.0

(51) Int. Cl. A47K 10/00; F26B 21/06

(52) U.S. Cl. CPC A47K 10/00; F26B 21/06

(57) ABSTRACT

A hand drier comprising communication means for communicating data to and/or from the hand drier.

### FIELD

This invention relates to a hand drier.

### BACKGROUND

Known hand driers are widely used in public places such for example as toilets where persons need to dry their hands after having washed their hands. The known hand driers are typically installed as stand-alone units, which must be serviced on site, placing a burden on service/maintenance personnel. In addition, it is difficult to monitor the energy usage of such driers, which can present a problem for facilities managers seeking to enhance the energy efficiency of a building.

It is an aim of the present invention to provide an improved hand drier.

### SUMMARY OF INVENTION

According to a first aspect of the present invention, there is provided a hand drier comprising communication means for communicating data to and/or from the hand drier.

The communication means may be for communicating the data to a central data collection facility remote from the drier.

The data communicated to the central data collection facility may include usage data indicating the number of drying operations the drier performs and/or the length of each drying operation. A drying operation can be understood to correspond to a period in which the drier is operable to dry a person's hands.

The drier may comprise operating means for initiating a drying operation. The operating means may be operable to terminate a drying operation. The operating means may be configured to signal the communication means when a drying operation is initiated and/or when a drying operation is terminated.

The operating means may be user-activated. For example, the operating means may be a button or switch operable by the user. In some embodiments, the operating means may comprise an audio sensor or voice recognition module that will initiate a drying operation when a user issues a verbal command in proximity to the drier. In some embodiments, the means may comprise an image sensor configured to initiate a drying operation upon detection of a user's face or other body, such as a fingerprint, for example.

The operating means may comprise detector means for detecting when a person's hands are in a position for being dried. The detector means may be an active detector means. The active detector means may be an acoustic active detector means, an electromagnetic active detector means, or an optical active detector means. Other types of active detector means may be employed. Generally, the active detector means operate to detect the presence and/or absence of the person's hands. Typically a low level signal will be sent, aiming at a specific point in space. When the person's hands are in that space, the presence of the hands will reflect a signal such that the detector means is able to decipher and thus trigger the initiation of a hand drying cycle. Conversely, when the person's hands are removed from the space, then the detector means will cause the hand drier to revert to its quiescent state. The detector means may alternatively be a passive detector means. The passive detector means may be an infrared passive detector means. Other types of passive detector means may be employed. The passive detector means is such that it does not transmit a signal but instead looks for a characteristic signal perhaps, for example, an infrared signal.

The data communicated to the central data collection facility may include performance data indicating operating parameters of the drier and/or whether a fault has occurred in the drier. For example, the performance data may indicate blower rotational speed and/or airflow through the apparatus. Alternatively, or in addition, the performance data may be used to indicate that a fault has occurred during the drier's installation.

The communication means may be configured to receive input data from a device located remote from the drier. The drier may be configured to adjust one or more of its operating parameters based on the input data. The input data may comprise data indicative of climatic conditions in the vicinity of the drier. For example, the input data may indicate the temperature and/or humidity of the drier's environment.

The input data may comprise control data that specifies operating parameters to be implemented by the drier. For example, the drier may include a motor and a blower and the operating parameters specified by the control data may include the speed of the blower and/or motor.

The hand drier may comprise a display screen for displaying media content during each drying operation. The hand drier may be configured to display advertising content on the screen during each drying operation. The hand drier may be configured to switch off display of the media content during the intervals between drying operations. Where the drier communicates usage data to a data collection facility, that usage data may include details of adverts that have been displayed on the screen during each drying operation.

According to a second aspect of the present invention, there is provided a system comprising a hand drier according to the first aspect and a central data collection facility located remote from the drier. The communication means may be configured to communicate the data to the central data collection facility over a communication link.

The system may comprise a plurality of driers according to the first aspect of the invention. The communication means of each drier may be configured to communicate data to the central data collection facility over the communication link.

The system may comprise a control facility located remote from each drier. The control facility may be configured to send control data to each drier, the control data specifying operating parameters to be implemented by the drier. The operating parameters that are specified in the control data sent to each drier from the control facility may be determined based on performance data received from each drier at the central data collection facility. Alternatively, or in addition, the operating parameters that are specified in the control data sent to each drier from the control facility may be determined based on the usage data received from each drier at the central data collection facility.

The system may include a billing module for calculating a fee payable for displaying adverts on the screens of the driers.

The communication means may communicate any suitable and desired data. The hand drier of the present invention is advantageous in that the data from the hand drier is able to be used in a wide variety of ways. The hand drier of the present invention is better than known hand driers because the known hand driers do not have the communication means.

The hand drier may be one in which the communication means is for communicating the data from the hand drier such as to optimise operation and/or location of the hand drier. The data from one hand drier of the present invention may be compared with the data from other hand driers. Where the data from hand driers of the present invention and in the same vicinity is compared, improvements may be obtained in location of the hand driers if it is determined from the data that one hand drier is in a more popular location than other hand driers.

The hand drier of the present invention may be such that the communication means communicates the data in a Duplex mode (i.e. simultaneous transmit and receive), a half Duplex mode (i.e. transmit only to a receiving station, or receive only from a transmitting station, or a Simplex mode (i.e. transmit or receive only). The communicated data may be generally employed to change operating parameters inside the apparatus of the present invention, for example the over-run time that the apparatus operates after a person has removed their hands from the vicinity of the apparatus and/or the speed of the blower.

The communication means may communicate the data to any desired position. The communicated data may be used for information feedback.

The hand drier of the present invention may include known components from known hand driers. Thus, for example the hand drier of the present invention may include a blower and a motor for driving the blower. The hand drier of the present invention may thus have some of or all the features of known hand driers, plus the additional advantageous feature of the communication means for communicating the data from the hand drier.

The hand drier may include a communication device for interfacing with a user's mobile phone or other electronic device when the user is in the vicinity of the drier. The communication device may comprise a near-field communication device. The communication device may comprise an audio signal generating means, for generating an audio signal recognisable by a user's phone or other electronic device. The drier may be configured to initiate display of media content on its screen on receipt of a return signal sent from the user's phone or electronic device in response to the audio signal.

According to a third aspect of the invention, there is provided a hand drier having a sensor for sensing a property of the surrounding environment and means for adjusting operating parameters of the drier in response to the sensed property. The property may relate, for example, to climatic conditions, such as temperature, or humidity, which can be measured using a range of sensors known in the art. The sensor(s) may be integrated within the drier.

### BRIEF DESCRIPTION OF FIGURES

Embodiments of the invention will now be described solely by way of example and with reference to the accompanying drawings in which:

FIG. 1 is a schematic diagram showing the components and operation of a known hand drier;

FIG. 2 is a schematic diagram like FIG. 1 but shows the components and operation of a hand drier in an embodiment of the present invention;

FIG. 3 shows in block diagram form components of a hand detector means for use in a hand drier of the present invention;

FIG. 4 is a schematic diagram showing the components of a communication means for use in the hand drier of FIG. 2;

FIG. 5 is a schematic diagram of a system comprising the hand drier of FIG. 2 and a data collection facility for receiving data sent from the hand drier.

FIG. 6 is a schematic diagram showing components and operation of a hand drier in an embodiment of the present invention;

FIG. 7 is a schematic diagram showing the components of a communication means for use in the hand drier of FIG. 6;

FIG. 8 is a schematic diagram of a system comprising the hand drier of FIG. 6 and an external device for transmitting input data to the hand drier.

FIG. 9 is a schematic diagram showing components and operation of a hand drier in an embodiment of the present invention;

FIG. 10 is a schematic diagram showing the components of a communication means for use in the hand drier of FIG. 9;

FIG. 11 is a schematic diagram of a system comprising the hand drier of FIG. 9 and a remote facility for receiving and sending data to and from the hand drier.

FIG. 12 is a schematic diagram showing components and operation of a hand drier in an embodiment of the present invention;

FIG. 13 is a schematic diagram of a system comprising the hand drier of FIG. 12 and a remote facility for receiving and sending data to and from the hand drier.

FIG. 14 is a schematic diagram showing the components of a communication means and a display module for use in the hand drier of FIG. 12;

FIG. 15 is a schematic diagram of a system comprising the hand drier of FIG. 12 and a remote facility for receiving and sending data to and from the hand drier.

FIG. 16 is a schematic diagram of a system comprising a plurality of hand driers that are arranged to communicate with a remote facility; and

FIG. 17 is a schematic diagram of a system comprising a plurality of hand driers that are arranged to communicate with a remote facility.

### DETAILED DESCRIPTION

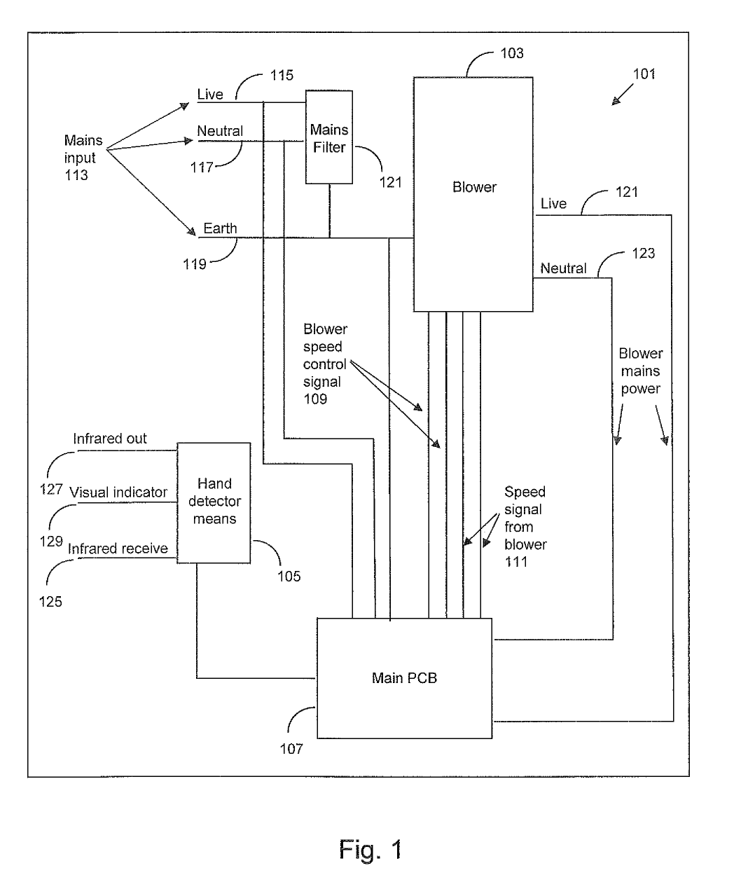

Referring to FIG. 1, there is shown in schematic form a known hand drier 101 comprising a combined blower and motor 103, for providing air for drying a person's hands. The hand drier 101 comprises detector means 105 for detecting when a person's hands are in a position for being dried. The detector means 105 operates such that it automatically turns the hand drier to on when a person's hands are in the position for being dried. The detector means 105 operates to turn the hand drier 105 off when the person's hands are removed from the position for being dried. The detector means 103 will usually operate when one or both of the person's hands are detected.

As can be seen from FIG. 1, the hand drier 101 is such that the detector means 105 is connected to a main printed circuit board 107 which controls operation of the hand drier 101. Thus, as shown, the main printed circuit board 107 is able to provide a blower speed control signal via lines 109 to the blower and motor 103 and to receive a blower speed signal from the blower and motor 103 via lines 111. In this way, the main printed circuit board 107 is able to control operation of the blower and motor 103.

The hand drier 101 has a mains input 113 with live, neutral and earth wires 115, 117, 119 respectively which are connected as shown. A mains filter 121 is connected between the live and neutral wire 115, 117, 119 and the blower and motor 103. The blower and motor 103 has live and neutral mains power wires 121, 123 connected between the blower and motor 103 and the main printed circuit board 107. The detector means 105 may be any suitable and appropriate active or passive detector means 105. As shown in FIG. 1, the detector means 105 has an infrared receive facility 125, an infrared transmit facility 127, and a visual and/or audible indicator facility 129.

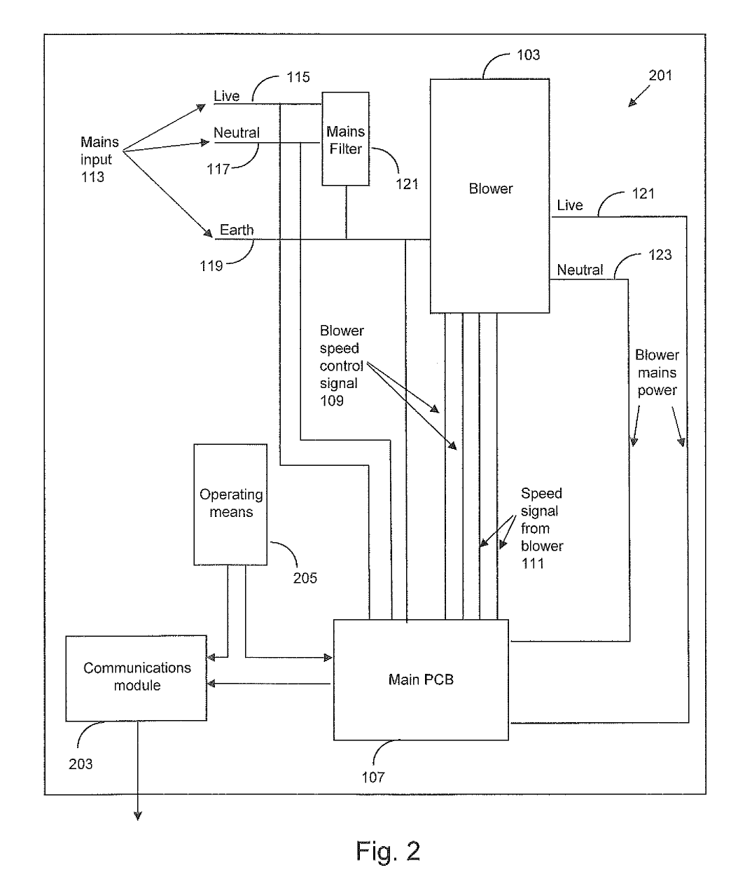

FIG. 2 shows a hand drier 201 of the present invention. Similar parts as in FIG. 1 have been given the same reference numerals for ease of comparison and understanding.

It will be seen from FIG. 2 that the hand drier 201 comprises communication means 203 in the form of a communications module for communicating data from the hand drier 201. The communication means 203 is connected to the detector means 105 and the main printed circuit board 107 as shown. The main printed circuit board 107 may be regarded as control means for the hand drier.

The communication means 203 is able to communicate the data from the hand drier 201 to a central data collection facility or wherever else may be required. The communicated information may be data for the hand drier 201, for example that which would enable the optimum operation of the hand drier 201 and/or the optimum location of the hand drier 201.

As shown, the drier 201 includes operating means 205 for initiating a drying operation. The operating means may, for example, comprise a hand detector means similar to that shown in FIG. 1. However, the person skilled in the art will understand that other forms of operating means are also possible. For example, the operating means 205 may comprise a button or switch that will cause the drier to activate the blower when pressed. Alternatively, the operating means 205 may be voice activated for example, the operating means may initiate drying upon detecting the sound “Start” from a user, or may include an image sensor configured to initiate a drying operation when a particular object (e.g. a person's face or finger) is detected in the field of view of the sensor. The operating means 205 may also be used to terminate a drying operation upon detecting further action by the user. For example, where a drying operating is initiated by pressing a button or switch, the operating means 205 may terminate that drying operation when the button or switch is pressed a second time. Alternatively, where the operating means 205 is voice operated, the operating means 205 may terminate the drying operation upon detecting a further audio signal from the user, such as “Stop.” In some cases, the operating means 205 may not require further input from the user in order to terminate a drying operation. For example, the drier may comprise a timer that is activated upon initiation of a drying operation and which will signal the blower to turn off once a predetermined amount of time has elapsed.

Upon being activated, the operating means 205 may send a signal to the communications module 203 to indicate the start of a drying operation. The operating means may also send a signal to the communications module 203 upon termination of a drying operation. In some embodiments, the operating means may send a continuous signal to the communications module 203 throughout the duration of a drying operation, with the signal then ceasing upon termination of the drying operation.

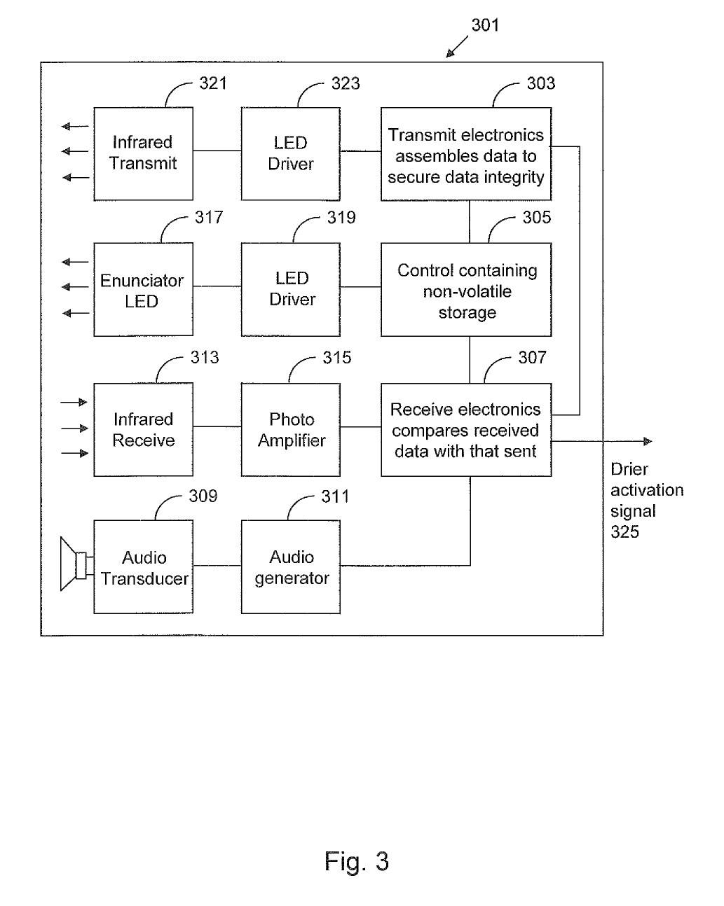

Referring now to FIG. 3, there is shown an example of a hand detector means 301 which is an example of the operating means for use in a hand drier of the present invention such for example as the hand drier 201. The hand detector means 301 comprises transmit electronics means 303 for assembling data to secure data integrity. The hand detector means also comprises control means 305 containing non-volatile storage. The control means 305 may organise both data communication and hand detection. Receive electronics means 307 receives data from the transmit electronics means 303 and compares the data with that sent. The receive electronics means 307 is connected to an audio transducer 309 via an audio generator 311 as shown. Detector means in the form of infrared detector means 313 is able to receive infrared signals as shown which are amplified by a photo amplifier 315. The photo amplifier is connected to the receive electronics means 307.

The control means 305 is connected to an enunciator light emitting diode 317 via a light emitting diode driver 319. The transmit electronics means 303 is connected to an infrared transmit means 321 via a LED driver 323 also as shown.

By comparing the infra-red signals that are transmitted and received at the hand detector means 301, the hand detector means is able to detect the presence of a person's hands in a position to be dried. On determining that a person wishes to use the drier (because their hands are in the drying position), the detector means outputs a drier activation signal 325. The drier activation signal 325 is transmitted to the main PCB of the drier, which in turn operates the motor/blower 103 such that the person's hands are dried. At the same time, the drier activation signal is also transmitted to the communication means 203. Thus, a signal is sent to the communication means for each drying operation. The main PCB may signal the blower to operate for as long as the drier activation signal is received at the main PCB.

The communication means 203 is able to communicate any required data from the hand drier 201 such as, for example, the number of times of operation of the hand drier 201 per day or between services. The communication means 203 is also able to communicate data such for example as the average length of operation of the hand drier 201 in each hand drying operation. The communication means 203 may communicate the data to any desired location.

The hand drier 201 may be in any desired and appropriate physical shape including the shapes of known hand driers. The hand drier 201 may also include any desired and suitable known components in known hand driers.

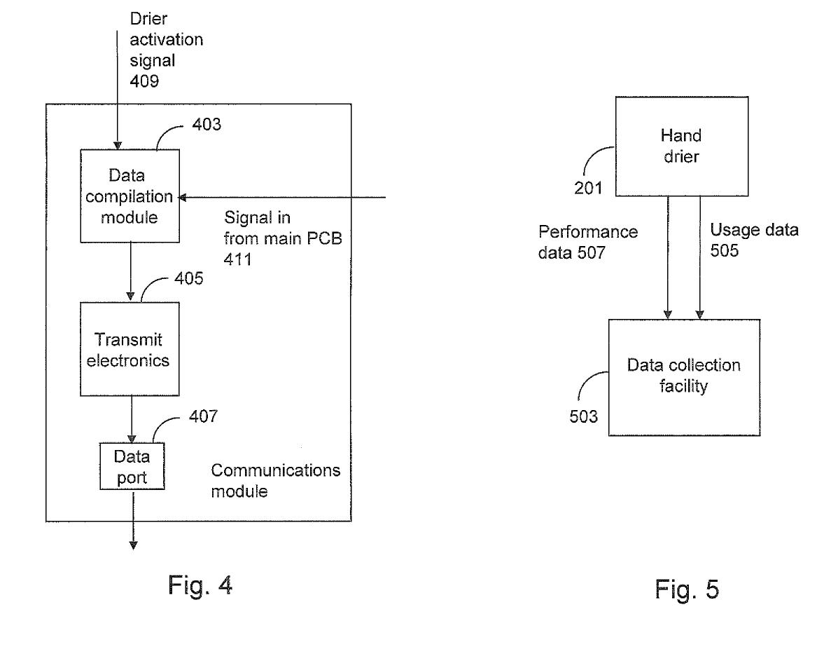

FIG. 4 shows an example of the communication means (communication module) according to an embodiment. The communication means includes a data compilation module 403, transmit electronics 405 and a data port 407. The data compilation module receives the drier activation signal 409 from the operating means each time the drier is used. In this way, the data compilation module 403 is able to compile usage data indicating the number of times the drier is used and/or the length of operation of the hand drier in each hand drying operation, for example.

As shown in FIG. 4, the data compilation module 403 may also receive an input signal 411 from the main PCB. The input signal 411 from the main PCB may be used to compile performance data for the drier. For example, the signal 411 received from the main PCB may indicate values of parameters such as blower rotational speed and amount of airflow through the apparatus, wherein the latter may be used to identify blocked airways within the drier. The data compiled by the data compilation module is prepared for transmission by the transmit electronics 405, which then transmit the data to a desired location via the communications port 407.

FIG. 5 shows a system comprising the hand drier of FIG. 2 and a remote data collection facility 503 with which the drier may communicate. The hand drier 201 communicates with the data collection facility 503 over a communication link that may comprise either a wired or wireless communication link. The hand drier uses the communication link to transmit the usage data 505 and/or performance data 507 to the data collection facility 503. Maintenance or service personnel can access the data from the data collection facility and in this way monitor the function of the hand drier without the need to visit the actual site at which the drier is located.

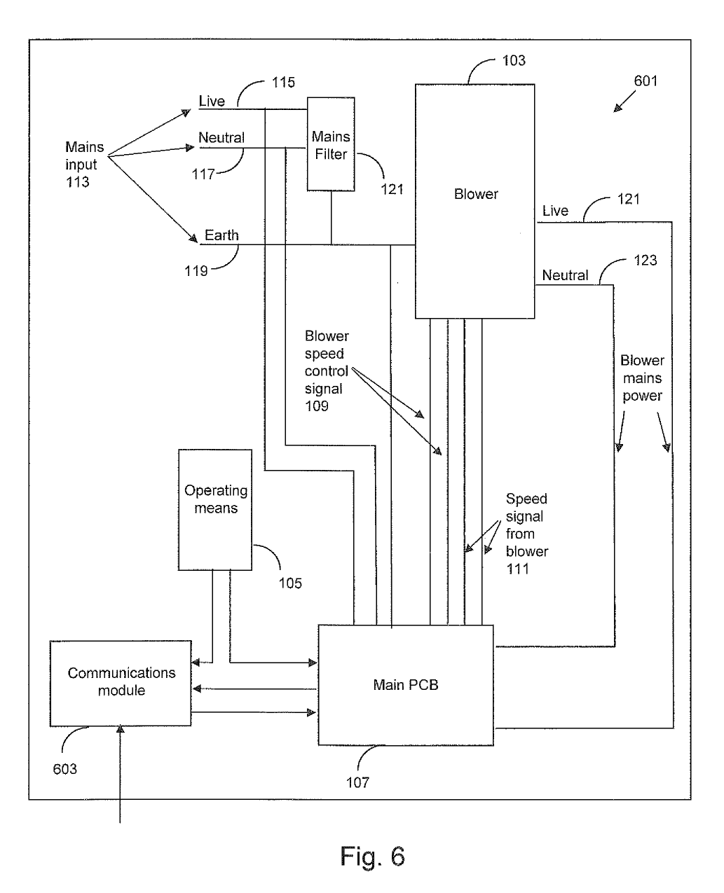

FIG. 6 shows a hand drier 601 according to another embodiment of the invention. Parts similar to those shown in FIG. 2 have been given the same reference numerals for ease of comparison and understanding. The hand drier of the present embodiment is similar to that shown in FIG. 2. However, in this case the communication means 603 is configured to receive data from outside of the drier and transmit data to the main PCB 107.

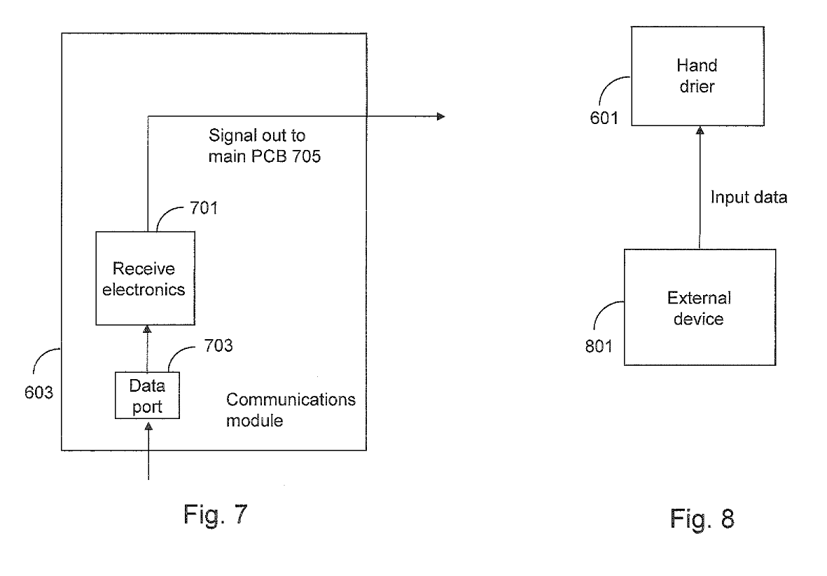

The communication means 603 of FIG. 6 is shown in more detail in FIG. 7. Here, the communication means include receive electronics 701 for receiving and processing data that is sent to the drier from a remote location and received via data port 703. In particular, the receive electronics are configured to process data that is sent to the drier in order to configure operating parameters of the drier including, for example, the blower/motor speed. On receiving data from the remote location, the receive electronics outputs a corresponding signal 705 to the main PCB, which then configures the operation of the drier accordingly.

FIG. 8 shows a system comprising the hand drier of FIG. 6 and an external device 801 configured to transmit data to the drier. The external device 801 communicates with the hand drier 801 over a communication link that may comprise either a wired or wireless communication link. The external device uses the communication link to transmit input data, which is in turn used to determine operating parameters of the hand drier 601.

In some embodiments, the external device may comprise a sensor for monitoring ambient climatic conditions in the drier's environment, such as the temperature and/or humidity of the room in which the drier is located. The external device may transmit data indicative of the ambient temperature/humidity to the drier, which will receive the data via the communications module and in turn output a corresponding signal to the main PCB, which can then configure the operation of the drier accordingly. In some embodiments, the drier may be pre-programmed to adopt specific operating parameters in response to changes in the ambient climatic conditions. For example, where the input data received from the sensor indicates that the temperature or humidity has reached a threshold value, the drier may adjust a particular operating parameter in order to compensate. For example, the drier may adjust the over-run time for which the drier operates after a person has removed their hands from the vicinity of the apparatus and/or the speed of the motor/blower. In other embodiments, the external device itself may itself specify the operating parameters to be adopted by the drier. That is, rather than indicating changes in temperature/humidity per se, the external device may instead transmit control data that specifies the actual operating parameters to be used by the drier.

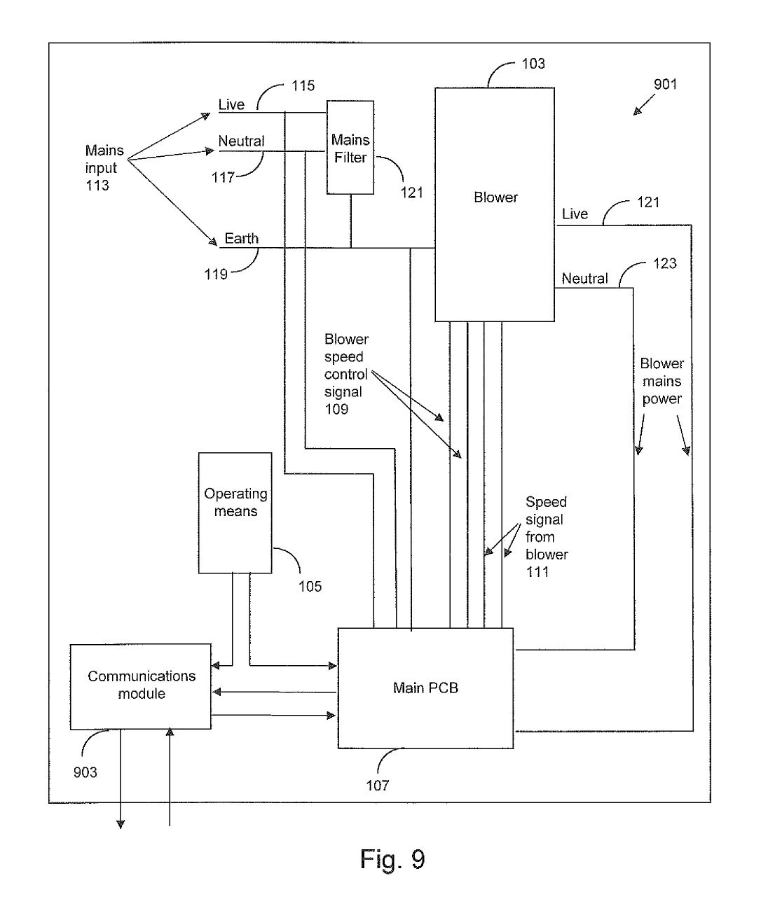

FIG. 9 shows a hand drier 901 according to another embodiment of the invention. Parts similar to those shown in FIG. 2 have been given the same reference numerals for ease of comparison and understanding. The hand drier of the present embodiment is similar to that shown in FIGS. 2 and 6. In this case the communication means 903 is configured to transmit data to the main PCB 107 and in addition, to receive data from the main PCB.

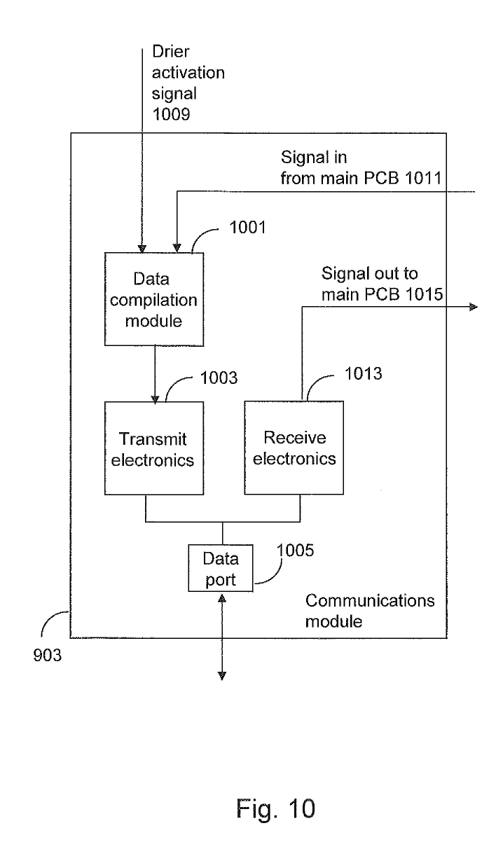

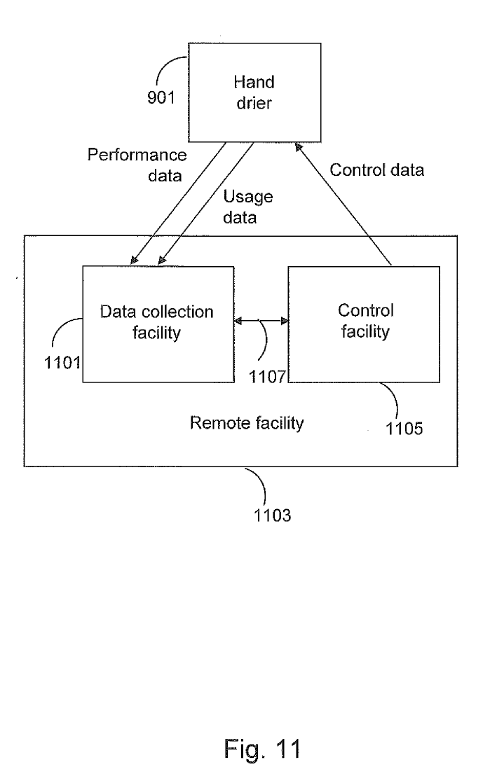

The communication means 903 of FIG. 9 is shown in more detail in FIG. 10. As in FIG. 4, the communication means includes a data compilation module 1001, transmit electronics 1003, and a data port 1005, wherein the data compilation module 1001 receives input signals 1009, 1011 from the operating means and the main PCB, respectively. In this embodiment, the communication module also includes receive electronics 1013 for receiving and processing data that is sent to the drier from a remote location. In particular, the receive electronics are configured to process control data that is sent to the drier in order to configure operating parameters of the drier including, for example, the blower/motor speed. On receiving control data from the remote location, the receive electronics outputs a corresponding signal 1015 to the main PCB, which then configures the operation of the drier accordingly.

FIG. 11 shows a system that includes the hand drier of FIG. 9. As in the system of FIG. 5, the system includes a data collection facility 1101 for receiving usage and/or performance data that is sent from the drier 901. In the present case, the data collection facility 1101 comprises part of a larger remote facility 1103 that includes a control facility 1105 used to send control data to the drier. The control data may be sent to the drier over the same communication link that the drier uses to communicate with the data collection facility.

The control data sent from the remote facility may be used to control operating parameters of the hand drier 901. For example, the control data may specify the over-run time that the apparatus operates after a person has removed their hands from the vicinity of the apparatus and/or the speed of the motor/blower. The control facility 1105 is able to access the data in the data collection facility 1101 and may adjust the control data that is sent to the drier accordingly. For example, in the event that there is a fault detected in the drier, this fault will be reported in the performance data received at the data collection facility 1103. The control facility may in turn be used to issue a command in the control data to switch the drier off, thereby avoiding the risk of any danger to users. In another example, the usage data may indicate periods of peak and/or minimal usage during the day. The control facility may be used to issue commands to the drier to enter a standby mode during those periods when demand is low, thereby saving energy.

It will be understood that the data collection facility 1101 and control facility 1105 may be located at the same site, or even comprised within the same computer module. In other embodiments, the control facility 1105 and data collection facility 1101 may be located at different sites (both remote from the drier). In each case, communication between the data collection facility 1101 and control facility 1105 may be possible via a suitable data connection 1107.

It will further be understood that, for embodiments described herein, the communication link between the hand drier and components of the remote facility may comprise a network connection; for example, the remote facility and the communication means of the hand drier may both be connected to the same local area network (LAN) or wireless local area network (WLAN), such that they are able to send data to one another over that network. Alternatively, or in addition, the hand drier and components of the remote facility may have respective internet connections and be able to send data to one another over the internet.

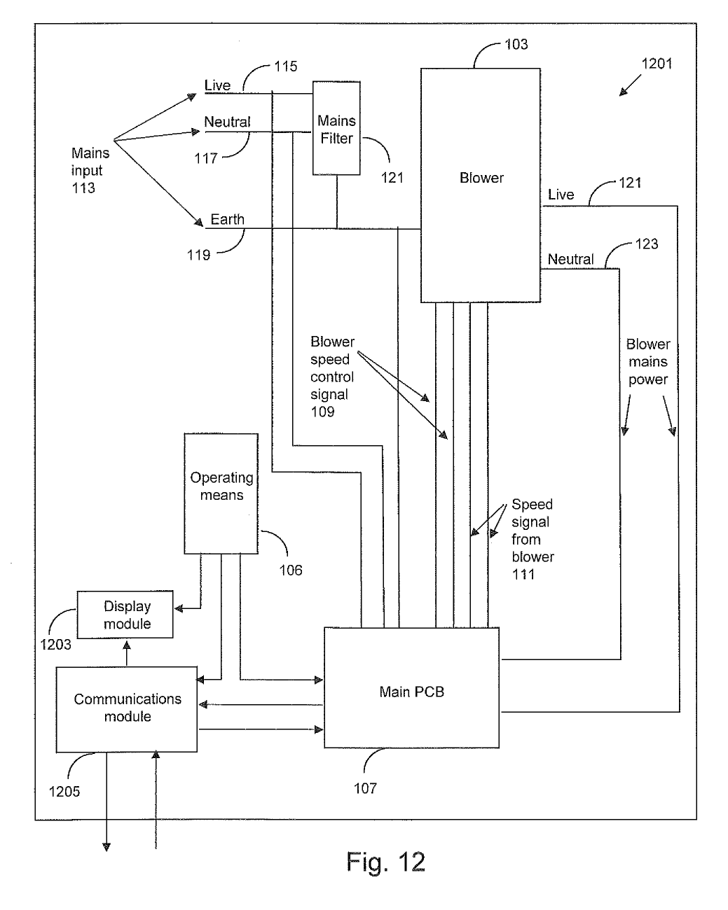

FIG. 12 shows an example of a hand drier 1201 according to a further embodiment. Parts similar to those shown in FIG. 2 have been given the same reference numerals for ease of comparison and understanding. In the present embodiment, the hand drier 1201 has a display module 1203 for displaying visual content to a person using the drier. The display module includes a screen that is, for example, a liquid crystal display (LCD) screen. Other types of display screens may also be used, such as an array of LEDS or organic LEDs (OLEDs), for example.

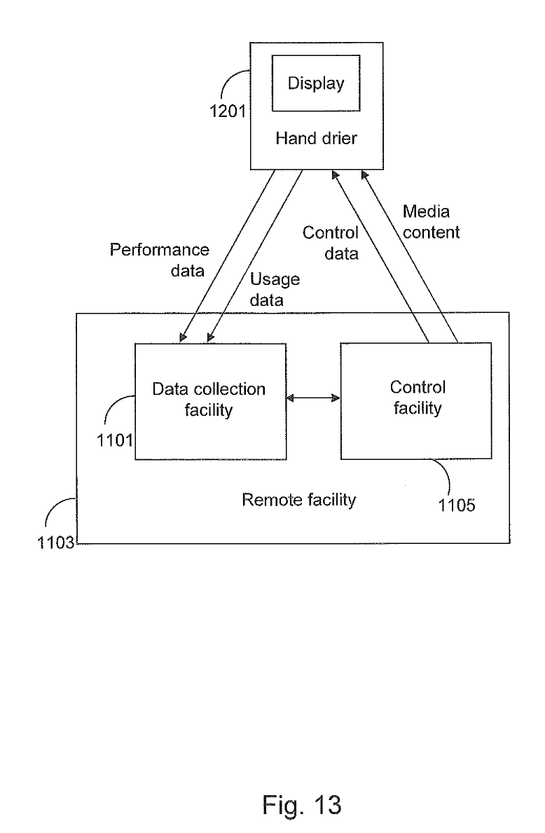

FIG. 13 shows a system comprising a hand drier 1201 such as that shown in FIG. 12. The system of FIG. 13 is similar to that shown in FIG. 11 and parts having the same function have been given the same reference numerals in these two figures. In comparison with FIG. 11, the system of FIG. 13 includes the additional feature that the control facility may be used to transmit media content to the drier for display on the screen.

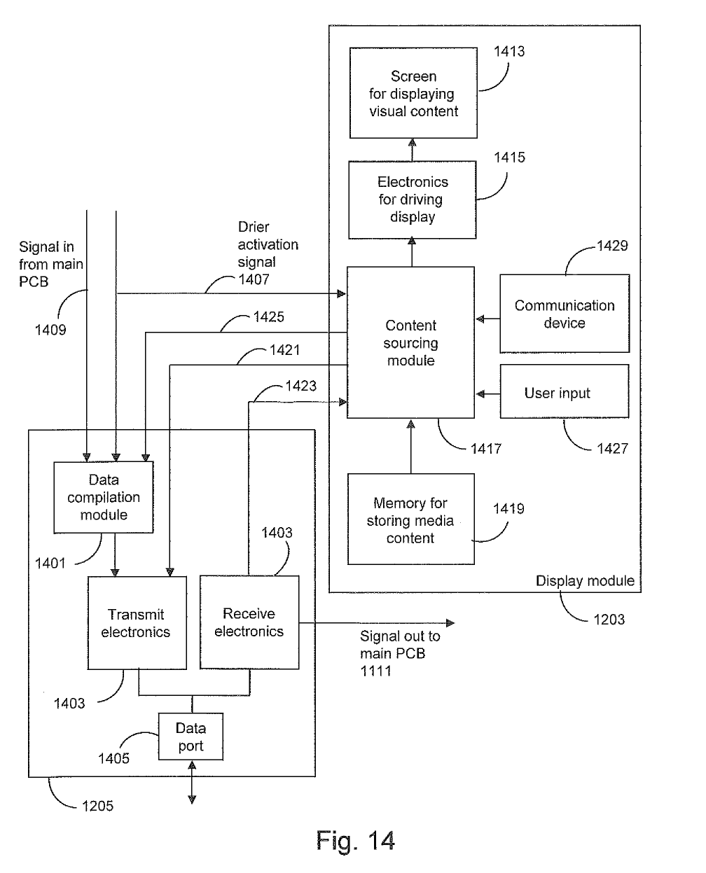

FIG. 14 shows an example of components that may be included within the display module 1203 and the communications module 1205 of FIG. 12. As in previous embodiments, the communications module 1205 includes a data compilation module 1401, transmit electronics 1403, receive electronics 1403 and a data port 1405. The data compilation module 1401 receives input signals 1407, 1409 from the hand detection means and the main PCB, respectively. The input signal 1407 from the hand detection means is used to compile usage data for the drier whilst the input signal 1409 from the main PCB is used to compile the performance data. The receive electronics 1403 is configured to process control data received from the remote facility 1103 and to output a signal 1411 to the main PCB for configuring the operating parameters of the drier.

The display module 1203 includes a screen 1413 for displaying visual content and electronics 1415 for driving the screen. Also included within the display module 1203 is a content sourcing module 1417 that is configured to select and source the content to be displayed on the screen 1413. The content sourcing module 1417 is arranged to forward the content to the electronics 1415 used to drive the display 1413.

As shown in FIG. 14, in addition to the data compilation module, the drier activation signal 1407 sent from the operating means is also input to the content sourcing module 1417. In this way, the content sourcing module 1417 is configured to source and supply content to the display electronics 1415 each time the hand drier is operated. For example, the content sourcing module 1417 may initiate the display of the content when the detection means detects that a person's hands are in the position for being dried and/or switch off the display of content when the person's hands are removed from that position.

The content sourcing module 1417 may source content from one of a number of different locations. In one example, content to be displayed on the screen is sourced directly from a memory module 1419 contained within the drier. In another example, the content may be sourced from a location outside of the drier (typically, the remote facility 1103 shown in FIG. 11). In this case, the content sourcing module is configured to send a content request 1421 to the transmit electronics 1403 of the communications module, which will in turn transmit the request to the external facility via the data port 1405. The requested content may be received through the data port from the remote facility. The receive electronics 1403 of the communications module may process the data and supply the data via a path 1423 to the content sourcing module 1417. In this way, the content sourcing module 1417 can stream live data from the remote facility.

When sourcing content, the content sourcing module is configured to transmit a signal 1425 to the data compilation module 1401 of the communication module. The signal 1425 that is sent from the content sourcing module to the data compilation module 1401 includes details of the content that is supplied to the screen 1413. The data compilation module 1401 may use the information received from the content sourcing module 1417 to update the usage data, such that the usage data includes details of the content that was screened on the display during each use of the hand drier.

The content sourcing module 1417 may select the content to be displayed based on a number of different inputs. In some embodiments, the display screen 1413 may be used to present the user with a choice of content, such that the user is able to select the content that they are particularly interested in. In such cases, as shown in FIG. 14, the content sourcing module may be configured to receive a user input signal 1427 and source the content accordingly.

Referring still to FIG. 14, the drier may include a communication device 1429 that will allow the drier to interface with a user's mobile phone or other electronic device when the user is in the vicinity of the drier. The communication device may comprise a radio device such as a near-field communication device 1429 that can recognise when a person is close to the drier by engaging in two-way communication with the user's mobile phone or device. On detecting the presence of a user via the communication device, the drier may initiate display of particular content on the screen. Alternatively, or in addition, the communication device 1429 may include an audio signal generating means, such as a loud speaker, configured to emit an audio signal for interfacing with the user's mobile phone or other electronic device. The audio signal may be encoded in a particular format recognised by the mobile phone/electronic device. The audio signal may, for example, be inaudible to the human ear, by broadcasting at frequencies outside of the range that the human ear is capable of perceiving. The audio signal may trigger software stored in the phone, such as a software application or “App”, to transmit a return signal (which may be, for example, a radio wave signal) back to the drier. Following receipt of this return signal, the drier will then initiate display of particular content on the screen. The audio signal may have a longer range than that of near-field communication devices, allowing the drier to interface with devices that are located further away from the drier.

In other embodiments, the content sourcing module may source content that is targeted to the user in question, by independently obtaining information about the user's particular tastes. For example, where a near-field communication device is used, the near field communication device may be used to provide the drier with details of items that the user has previously searched for on the Internet, by reading out search results directly from the user's phone when the phone is brought into close proximity of the drier. Having retrieved the information from the user, the content sourcing module 1417 may select appropriate content to display to the user. Alternatively, or in addition, where the communication device 1429 transmits an audio signal to the user's phone or other electronic device, that signal may trigger the phone/electronic device to upload the results of previous searches to an internet based server, from where they can be downloaded to the drier an the content sourcing module via the communication module 1205.

The communication device may also serve as the operating means for the drier. For example, where a near-field communication device is used, the device may trigger the initiation of a drying operation on determining the presence of a user in the vicinity of the drier.

The content displayed on the screen may include energy usage data (i.e. details of the energy being used to dry the person's hands) that is displayed to the user in a user friendly manner. In this way, the display screen can allow the user to explore their energy consumption, educating them about energy usage.

In some embodiments, the content displayed on the screen may include interactive games that a user can play whilst drying their hands. The usage data that is received from the drier at the data collection facility may be analysed to build up a picture of which games are most appealing to users. The analysis could, for example, be passed on to games designers who may use it for refining existing games and in designing new ones.

In some embodiments, the content displayed on the screen 1413 may include advertising content in the form of individual images or video sequences. The advertising content may be stored at the control facility 1105 and streamed from the control facility 1105 over the communications link when the drier is operated (e.g. when a person's hands are detected at the drier). In another example, the advertising content may be uploaded to the drier from the control facility 1105 in advance and stored in the memory 1419 at the drier itself, ready to be displayed when a user operates the drier.

In addition to helping companies to market their products, the display of advertising media on the drier may also help to improve hygiene, first by encouraging people to use the drier (in association with which they will be minded to wash their hands) and secondly, by encouraging people to dry their hands thoroughly as their attention is held by the content displayed on the drier.

In some embodiments, the usage data that is sent from the drier to the data collection facility may include a record of the adverts that were displayed each time the drier was in use. Where a number of adverts are shown during the course of a single usage, the usage data may indicate the adverts that were shown during the time the drier was in use and the duration of each one. The usage data may also indicate whether or not the last advert in the sequence was shown in full, or whether the usage was curtailed before the advert reached its conclusion.

By including a record of the adverts displayed during use of the drier, the usage data can provide useful feedback to e.g. advertising agencies that may use the drier as a platform for advertising different products. Users will often draw their hands away from the drier as soon as they feel their hands have reached a satisfactory level of dryness (which may still be quite damp). However, in the event that an advert is showing that captures their attention, the usage will be extended. By analysing which adverts were shown during the course of each usage and the length of that usage, one can determine which adverts have a higher user interest and are, therefore, most likely to be effective in influencing people's tastes. If a particular advert is correlated with a higher length of time of usage, then that would suggest that that particular advertisement is particularly captivating. In addition, it will be possible to determine the average time users spend looking at each advertisement on the screen.

The hand drier shown in FIG. 12 can be used to implement a scheme whereby a building manager or estate manager can bill advertising agencies for hosting advertising content on the driers installed throughout an estate. The usage data received from the driers provides an accurate record of the number of times a particular advert has been viewed by a consumer. In comparison with other forms of advertising (e.g. television advertising), the advertising agency is assured that the advert will have received the attention of a user each time it was “aired”, since adverts will be displayed when the drier is in use (meaning there is at least one guaranteed viewer) and there will typically be few distractions to divert the user's attention in locations where a hand drier is situated, such as a washroom, for example. Moreover, as discussed above, where adverts are correlated with a higher average length of time of usage, then that would suggest that the advert is particularly captivating for users.

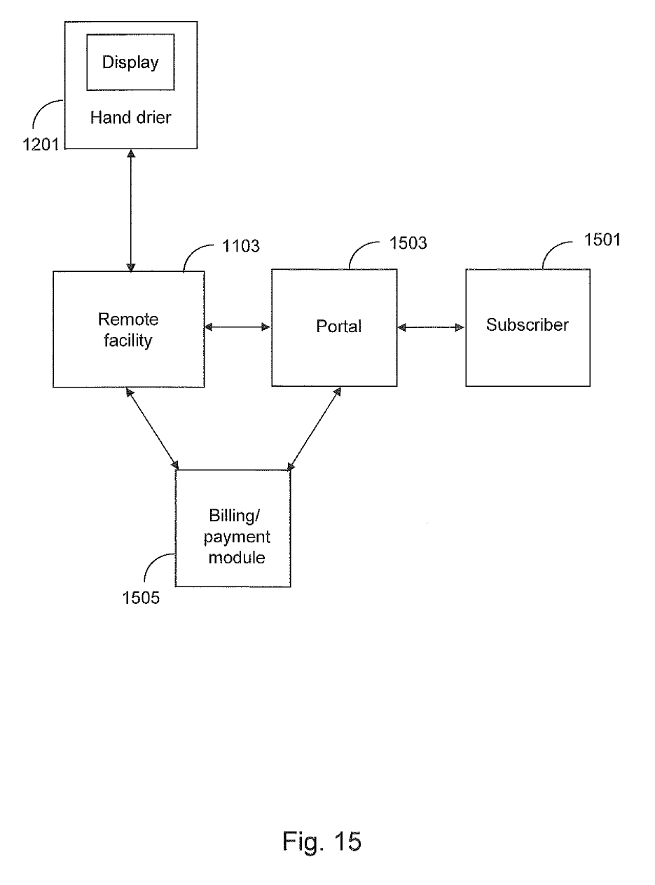

FIG. 15 shows an embodiment in which such a billing scheme can be implemented. In this embodiment, a subscriber (typically an advertising agency) 1501 that provides advertising content to be displayed on the drier 1201 is able to access information from the remote facility 1103 via an online web portal 1503. The portal 1503 allows the advertising agency 1501 to determine the number of times each advert has been displayed on the drier, the time of day at which it was displayed and whether or not the advert was viewed in full or partially (because the user finished drying their hands before the advert ended, for example). The information in the portal 1503 may also include information about the location of the hand drier 1201, for example if the drier is installed in a men's washroom or a women's washroom.

The portal may also show information about the advertising agency's running costs i.e. the amount presently owing to the building manager for displaying the advert(s) on the drier 1201. In the present embodiment, the amount charged will correlate with the usage data, with charges being accrued each time a particular advert is aired. In one example, the building manager may bill the advertising agency on a monthly basis. Throughout the course of each month, the advertising agency may access the portal to determine the current charges accrued for that month.

In the present embodiment, the portal 1503 may also provide a means for online payment to the building manager. For example, the portal 1503 may provide a link to a billing/payment module 1505 or online banking site, whereby funds can be transferred directly from the advertising agency account to the building manager's account. For convenience, charges may be billed on direct debit, with the amounts transferred being shown in the portal 1503. In this way, the use of a display for advertising purposes can allow building managers to offset the costs involved in purchasing and installing a hand drier by selling advertising space to advertising agencies. The agencies can in turn use the usage data provided by the driers to establish how much air time their adverts receive, or are likely to receive, allowing costs to be managed effectively.

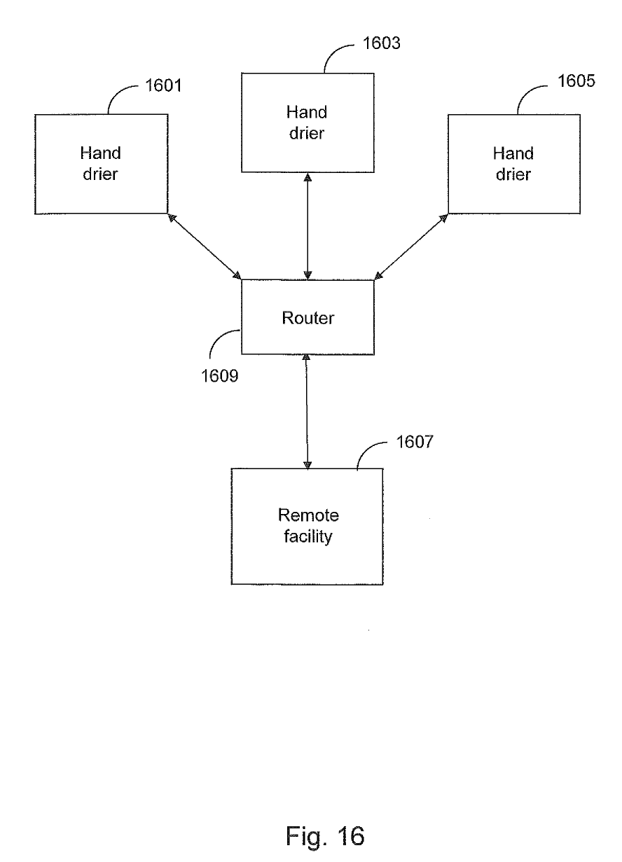

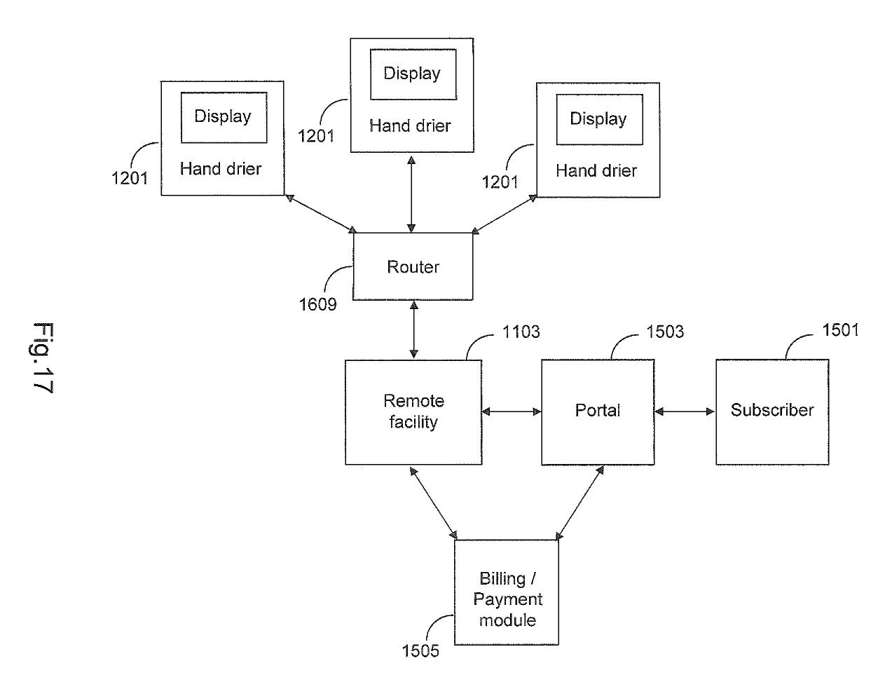

Embodiments will now be described in which a plurality of hand driers are arranged in a network. An example of such a networked arrangement of driers is shown in FIG. 16. The hand driers 1601, 1603, 1605 may have the same components of any hand drier previously described herein. In the present embodiment, each hand drier may be located in a different part of a building, or at different points throughout the same room in the building, typically a washroom.

In the embodiment shown in FIG. 16, the hand driers are each able to communicate with a remote facility 1607 via a router means 1609. The remote facility 1607 may comprise a data collection facility similar to that shown in FIG. 5. Alternatively, the remote facility 1307 may comprise the same components as the control remote facility 801, 1105 shown in FIGS. 8, 11 and 13. Each respective communication link between the router and a drier may be either a wired or wireless communication link. Similarly, the communication link between the router 1609 and the remote facility 1607 may be a wired or wireless communication link.

As before, the hand driers 1601, 1603, 1605 are configured to transmit usage data including, for example, the number of times the hand drier is used and/or the length of use of the hand drier in its on mode. In addition, the hand drier may transmit performance data including, for example, blower rotational speed and amount of airflow through the apparatus, wherein the latter may be used to identify blocked airways within the drier.

Where multiple driers are located within a building or within multiple buildings on an estate, the usage data can provide the facilities manager with a clear picture of energy usage across that installation. This offers an improvement over conventional means for determining energy usage in buildings, which are typically based on best estimates and which result in inaccurate data and false assumptions being made.

In this embodiment, the remote facility 1607 may store drier details for each drier in the network. The drier details may include one or more of the drier's serial number, the date the drier was installed in the building, the room of the building in which the drier is located, the number of other driers in the immediate vicinity (for example, number of driers in the same room) and the position of the drier within the room. The position may specify the height of the drier above the ground and distance from sink areas, entrance to the room and any vents located in the wall, for example.

The data received from each drier 1601, 1603, 1605 may be compared with one another; specifically, the networked arrangement of driers can allow maintenance/service personnel to compare the usage and/or performance of each hand drier by accessing data at the remote facility. Where the data from hand driers of the present invention and in the same vicinity is compared, improvements may be obtained in location of the hand driers if it is noted from the data that one hand drier is more popular in its use due to its location than other hand driers. For example, by comparing usage data amongst the driers, the maintenance/service personal may determine that one of the hand driers has a much higher usage than the others, suggesting that additional driers should be installed in the same location in order to reduce the load on that drier. Alternatively or in addition, the usage data may be used to determine an optimum distribution for different kinds of driers, where each kind of drier has, for example, different components and/or operating characteristics.

In another example, by comparing performance data from each drier, the maintenance/service personnel may determine that driers positioned at a particular point in a room (e.g. those in close proximity to a doorway) are prone to more errors than those at other points and should, therefore, be repositioned.

The performance data may further be used to identify any faults that are common amongst the driers and which may, therefore, serve as an indication that a particular element of drier needs to be replaced or redesigned. In this way, the performance data can be used to improve processes for manufacturing the driers.

Thus, by comparing the usage and/or performance data received from multiple driers, it becomes possible to build up a picture of the most effective number and/or location of driers in a particular building.

As in embodiments previously described, the remote facility 1607 may comprise a control facility that can be used to set and control operating parameters of each hand drier by sending control data to the driers over the network. As before, the control data may be used to control, for example, the overrun time that the apparatus operates after a person has removed their hands from the vicinity of the apparatus and/or the speed of the blower.

The control facility may send individual control data to each drier, such that different driers in the network are configured to run with different operating parameters. The operating parameters assigned to each drier may subsequently be compared with the usage data and/or performance data received from each drier to determine an optimum set of operating parameters for assigning to each drier.

It is possible that driers that have a high usage will have a different set of optimum operating parameters to those for which usage is lower. In one simple example, in driers that have a low rate of usage, it may be possible to operate the motor at higher speeds. By analysing the data received from each drier at the remote facility, it may be possible to determine optimum operating parameters for each drier and to configure each drier accordingly. By setting individual operating parameters for each drier, the efficiency of the site as a whole can be improved, helping to reduce waste energy and carbon footprint.

FIG. 17 shows an example of another embodiment that combines features shown in FIGS. 15 and 16 and discussed above in relation to those figures. For ease of understanding, parts having the same function as those discussed in relation to previous embodiments are given the same reference numerals. In this system, a number of hand driers 1201 are arranged in a network, with each drier having its own display screen for displaying visual content. As before, the content displayed on each drier 1201 may include advertising content in the form of individual images or video sequences. In this embodiment, the control facility (comprised within the remote facility 1103) may be used to coordinate the display of adverts at different sites. For example, the control facility may transmit different adverts to driers located in a men's washroom and those located in a women's washroom.

Each drier 1201 is configured to transmit usage data to the remote facility, where that usage data includes a record of the adverts displayed during use of the respective drier. Where adverts are chosen by user selection, the usage data received from the different driers can be analysed to determine whether adverts are more commonly chosen in certain locations that have a particular user demographic, such as e.g. male/female washrooms.

As before, the driers may also host interactive games that a user may play whilst drying their hands. In this case, the networked nature of the driers means that users may compete with users on other driers, thereby competing with other users at different locations. This type of engagement will educate, and promote healthy competition between ‘smart buildings’ and increase the interaction with driers.

It is to be appreciated that the embodiments of the invention described above with reference to the accompanying drawings have been given by way of example only and that modifications may be effected. For example, although the embodiments described relate to situations in which data is transmitted to/received from locations remote from the drier, many of the concepts disclosed will be applicable to cases in which data is transferred between components that comprise part of the drier itself. For example, it will be understood that where the drier is configured to receive data from a climatic sensor and to adjust its operating parameters accordingly (as has been described above in relation to FIG. 8), the sensor itself need not be located remote from the drier, but may be attached to the drier or integrated within the drier.

Individual components shown in the drawings are not limited to use in their embodiments and they may be used in other embodiments and in all aspects of the invention.

1. A hand drier comprising communication means for communicating data to a data collection facility remote from the hand drier;
wherein the data communicated to the data collection facility includes usage data indicating the number of drying operations the drier performs and/or the length of each drying operation.

2. (canceled)

3. (canceled)

4. A hand drier according to claim 1, wherein the drier comprises operating means for initiating a drying operation.

5. A hand drier according to claim 4, wherein the operating means is operable to terminate a drying operation.

6. A hand drier according to claim 4, wherein the operating means is operable to signal to the communication means when a drying operation is initiated and/or terminated.

7. A hand drier according to claim 4, wherein the operating means comprises detector means for detecting when a person's hands are in a position for being dried.

8. A hand drier according to claim 7 in which the detector means is an active detector means.

9. A hand drier according to claim 8 in which the active detector means is an acoustic active detector means, an electro-magnetic active detector means, or an optical active detector means.

10. A hand drier according to claim 7 in which the detector means is a passive detector means.

11. A hand drier according to claim 10 in which the passive detector means is an infrared passive detector means.

12. (canceled)

13. A hand drier according to claim 1, wherein the communication means is configured to receive input data from a device located remote from the drier, wherein the drier is configured to adjust one or more operating parameters based on the input data.

14. A hand drier according to claim 13, wherein the input data comprises data indicative of climatic conditions in the driers vicinity.

15. A hand drier according to claim 14, wherein the input data indicates the temperature and/or humidity in the driers environment.

16. A hand drier according to claim 13, wherein the input data comprises control data that specifies operating parameters to be implemented by the drier.

17. A hand drier according to claim 38, wherein the drier includes a motor and a blower and the operating parameters include the speed of the blower and/or motor.

18. A hand drier according to claim 1, wherein the hand drier comprises a display screen for displaying media content during each drying operation.

19. A and drier according to claim 18, wherein the hand drier is configured to display advertising content on the screen during each drying operation.

20. A hand drier according to claim 18, wherein the hand drier is configured to switch off display of the media content during the intervals between drying operations.

21. A hand drier according to claim 20, wherein the usage data further includes details of adverts that have been displayed on the screen during each drying operation.

22. A hand drier according to claim 1, comprising a communication device for interfacing with a user's mobile phone or other electronic device when the user is in the vicinity of the drier.

23. A hand drier according to claim 22, where the communication device comprises a near-field communication device.

24. A hand drier according to claim 22, wherein the communication device comprises an audio signal generating means, for generating an audio signal recognisable by a user's phone or other electronic device.

25. A hand drier according to claim 24, wherein the hand drier comprises a display screen for displaying media content during each drying operation, wherein the drier is configured to initiate display of media content on receipt of a return signal sent from the user's phone or electronic device in response to the audio signal.

26. A system comprising a hand drier according to claim 1 and a data collection facility located remote from the drier, wherein the communication means is configured to communicate the data to the data collection facility over a communication link.

27. A system comprising a hand drier according to claim 1 and a control facility located remote from the drier, wherein the control facility is configured to send control data to the drier over a communication link, the control data specifying operating parameters to be implemented by the drier.

28. A system according to claim 26, comprising a plurality of the driers, wherein the communication means of each drier is configured to communicate data to the data collection facility over the communication link.

29. A system according to claim 27, comprising a plurality of the driers, wherein the communication means of each drier is configured to receive control data from the control facility over the communication link.

30. A system comprising:
a hand drier according to claim 1;
a central data collection facility located remote from the drier; and
a control facility located remote from the drier,
wherein the communication means is configured to communicate data to the central data collection facility and the control facility is configured to send control data to the drier, the control data specifying operating parameters to be implemented by the drier.

31. A system according to claim 30 comprising a plurality of the driers, wherein the communication means of each drier is configured to communicate data to the central data collection facility over the communication link and to receive control data from the control facility, the control data specifying operating parameters to be implemented by the drier.

32. A system according to claim 31, wherein the operating parameters specified in the control data sent to each drier from the control facility are determined based on performance data received from each drier at the central data collection facility.

33. A system according to claim 31 wherein the operating parameters that are specified in the control data sent to each drier from the control facility are determined based on usage data received from each drier at the central data collection facility.

34. A system comprising: a hand drier according to claim 19, wherein the system further includes a billing module for calculating a fee payable for displaying the adverts on the screens of the drier.

35. A hand drier having a sensor for sensing a property of the surrounding environment and means for adjusting operating parameters of the drier in response to the sensed property.

36. A hand drier according to claim 35, wherein the property relates to climatic conditions of the environment of the drier.

37. A hand drier according to claim 37, wherein the sensor is a temperature or humidity sensor.

38. A hand drier comprising communication means for communicating data to a data collection facility remote from the hand drier;
wherein the data communicated to the data collection facility includes performance data indicating operating parameters of the drier and/or whether a fault has occurred in the drier.
